(19) United States
(12) Patent Application Publication
(10) Pub. No.: US 2010/0049572 A1
(43) Pub. Date: Feb. 25, 2010

(54) ASSOCIATION OF BODY SHOPS WITH RETAIL NETWORK

(76) Inventor: Robert E. BERMAN, King of Prussia, PA (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(21) Appl. No.: 12/546,135

(22) Filed: Aug. 24, 2009

Related U.S. Application Data
(60) Provisional application No. 61/090,943, filed on Aug. 22, 2008.

(51) Int. Cl. G06Q 10/00; G06Q 30/00

(52) U.S. Cl. 705/8; 705/14.4; 705/26; 705/400

(57) ABSTRACT

A buyer-seller-provider matching system that uses an estimating/scheduling/pricing system to match buyers with providers who accept the work at the price and to complete the work within a specific time. A computer system that comprises a repository of information about the work to be performed, available participating body shop, pricing, time available to perform work and transport of the vehicle that may be provided over a network for users to access information about the work order. The matching system incorporates the use of existing collision estimating software that transfer the work and pricing information to a scheduling program that is then transmitted to participating body shops for their review to accept or reject the work. On a real time basis the system will transmit the decisions of the participating body shop and award the work, schedule pick up of the vehicle and time for delivery back to the seller.

### CROSS REFERENCE TO RELATED APPLICATIONS

This application claims priority to U.S. Provisional Application No. 61/090,943 filed on Aug. 22, 2008. The disclosure of which is incorporated by reference herein in its entirety.

### FIELD OF INVENTION

The present application relates to an association of body shops. More particularly, the present application relates to an association of body shops with a network of retail centers.

### SUMMARY

In one embodiment, a national, regional or local network of retail centers is associated with a plurality of independent body shops. The body shop services may be marketed to consumers by using a well established national brand of network of retail centers. Alternatively, a newly established network of retail centers may be employed. The network of retail centers may be a network of centers wholly owned by a corporation or other entity. Alternatively, the network of retail centers may be affiliated through franchise arrangements.

The network of retail centers may employ an examination to certify and/or qualify participating body shops. The examination may also be used to market to consumers. The network of retail centers may also employ a guarantee or warranty of body shop services that may also be used to market to consumers.

Body shops may elect to participate to become associated with a national brand and have the ability to be part of an advertising program to expand their business. Participation in the network may create new business that otherwise would not likely come to their shop. Body shops may also benefit in future buying power thereby lowering their cost of goods and increasing their profit opportunity.

A network of retail centers may elect to associate with body shops to leverage existing retail center locations with relatively little capital investment or increase in operating expenditures. Possible benefits include increased revenue through fees, royalties, product sales with minimal capital investment. Future product sales may not require taking possession of even one SKU. The association with body shops may also attract a broader base of consumers and trade business opportunities, and provide additional lead base to sell existing services. The association may also be used to promote the brand name of the network of retail centers and provide an expanded business model for new franchise sales.

### BRIEF DESCRIPTION OF THE DRAWINGS

In the accompanying drawings, tables and flowcharts are illustrated that, together with the detailed description provided below, describe exemplary embodiments of the claimed invention. Like elements are identified with the same reference numerals.

It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, the drawings are not to scale and the proportion of certain elements may be exaggerated for the purpose of illustration.

FIG. 1 is a block diagram illustrating a simplified diagrammatic representation of a network of retail centers and body shops;

FIG. 2 is a block diagram illustrating a simplified diagrammatic representation of interaction between a customer, a retail center, and a body shop.

### DETAILED DESCRIPTION

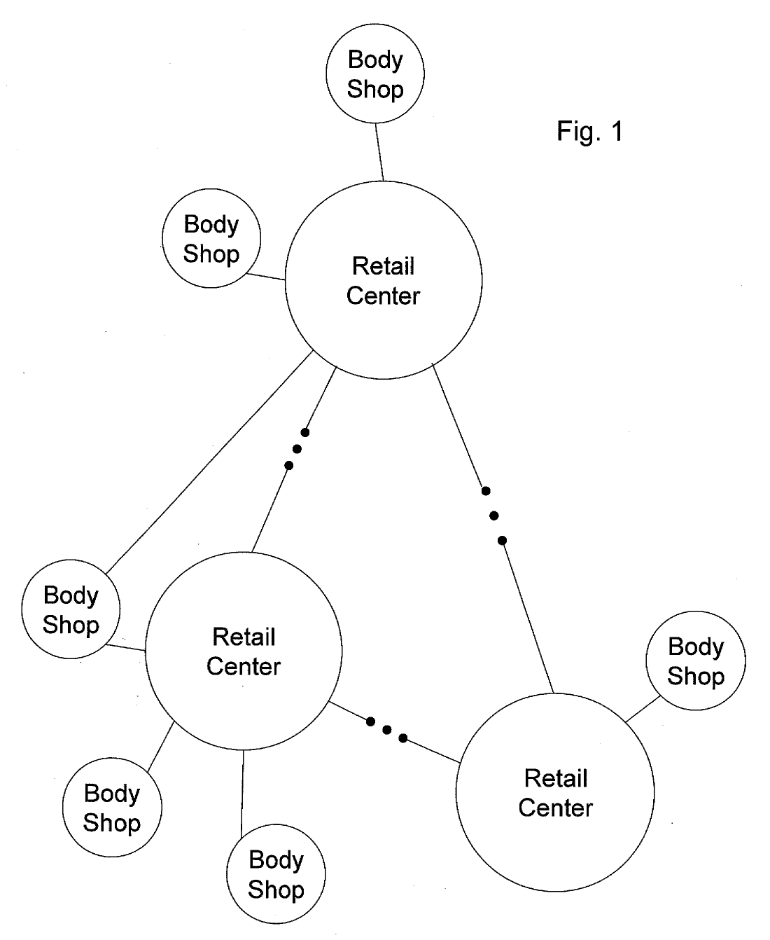

FIG. 1 illustrates a network of retail centers (hereafter, collectively, “the Company”). For illustrative purposes, only three retail centers are shown. It should be understood that the Company may employ any number of retail centers.

As shown in FIG. 1, each retail center is associated with one or more body shops. The number of body shops associated with each retail center may vary based on several factors, including geography, customer need, and quality of service. For example, a retail center that is in close geographic proximity with many body shops may become associated with several body shops. However, if customer need is low, or if the body shops do not meet standards set by the Company, a retail center may only become associated with a single body shop, or no body shops.

In populated areas, the Company may have several retail centers. In such cases, a body shop may be in close geographic proximity to two or more retail centers. Therefore, it is possible for a body shop to be associated with two or more retail centers. In one embodiment, the body shop may be evaluated on a national or regional level, and upon passing the evaluation, it will become associated with all retail centers of the company that are located within a predetermined distance. In an alternative embodiment, each retail center will evaluate the body shop.

In one embodiment, the Company specializes in automobile related services, such as oil changes, or general maintenance. In another embodiment, the Company specializes in automobile related products, such as parts. In another embodiment one or more estimating retail locations may be established to provide estimating services (hereafter, an “estimating retail center”) as a retail kiosk or free standing or in-line retail location. In yet another embodiment, the Company is a general purpose retailer or wholesale club. However, it should be understood that the Company may be any national, regional, or local chain of retail centers.

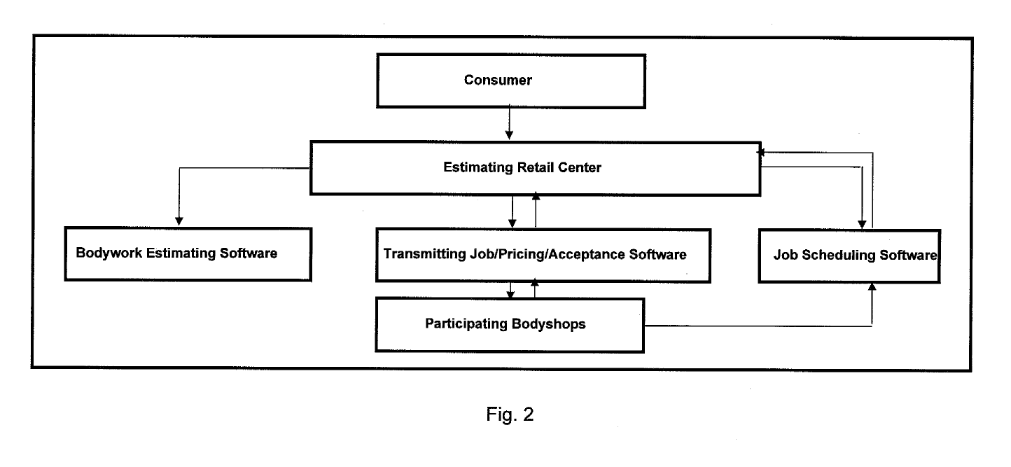

FIG. 2 illustrates the interaction between a customer, a retail center, and a body shop. In the illustrated embodiment, a consumer visits a retail center of the Company that provides estimating services The estimating retail center employs estimating software and trained individuals to provide the consumer with a cost estimate for requested body work. If the consumer accepts the estimate, the estimating retail center further employs software to transmit the request to a participating body shop. Upon receiving the request, the participating body shop may accept the request and schedule the job, or it could refuse the request. If the job is accepted, the body shop further provides an estimated time of completion. Transportation of the automobile may be arranged by the body shop or by the estimating retail center.

Due to the Company's national, regional or local presence and individual store locations, the consumer would be able to have their vehicle estimated at locations more convenient and safer than where body shops are typically located due to significant zoning issues. Additionally, the store hours of the Company locations may be more convenient for a consumer than the store hours of body shops.

One aspect of this system and method is to leverage the business assets and retail locations of the Company and to provide estimating services for auto body collision, repair & painting to one or more of retail, trade, insurance and fleet customers by developing a proprietary network of one or more of independent, dealer and chain body shops that will enter into an agreement with the Company to provide these services.

The method includes steps for establishing a network, including:
1. Provide estimating software. In one embodiment, the software is existing software that is generally accepted by the auto collision & painting industry and vehicle insurance providers. In an alternative embodiment, the software is written specifically for this purpose.
2. Provide training to educate current Company employees or new employees hired for this purpose to develop accurate and dependable skills in estimating auto body collision repair and paint work for vehicles.
3. Provide training to educate current or new employees hired for this purpose to effectively “sell” these services to retail, trade, insurance and fleet customers.
4. Market these services to the retail, trade, insurance and fleet customer utilizing appropriate advertising messaging and media to each.
5. Select potential participating body shops. In one embodiment, the step of selecting potential participating body shops is performed on a national level, through a central selection center. In an alternative embodiment, the step of selecting potential participating body shops is performed on a regional level, through a regional selection center. In another alternative embodiment, the step of selecting potential participating body shops is performed on a local level, by one or more local Retail Centers in the Company. Participating body shops may display signage identifying themselves as a business partner of the Company.
6. Evaluate selected potential participating body shops. As with the selection step, the step of evaluating potential participating body shops may be performed at a national, regional, or local level. In one embodiment, the potential participating body shops are evaluated using national uniform standards. In alternative embodiments, the potential participating body shops are evaluated using regional or local standards.
7. Certify potential participating body shops that pass the evaluation step.
8. Create an appropriate legal document to be used with participating body shops. This legal document will, among other things, set forth the terms and conditions, payments and other obligations to become part of the Company's proprietary network of body shops.
9. Develop a process for moving the vehicles for the estimating location to the participating body shop and then back to the estimating location. In one embodiment, this process may be based on existing models used by companies such as Enterprise Car Rental, dealers, etc.
10. Utilize software to allow for real time scheduling of work to be at network stores.
11. Create a guarantee/warranty program.

Revenue generation opportunities:
1. Company locations may receive an estimating fee for each vehicle “sold” (i.e., the customer accepts the estimate and agrees to pay for the work performed.)
2. Each participating body shop pays a “royalty” to the Company or the referring location based on the total dollar amount of the repair order.
3. Each participating body shop could be assessed a weekly or monthly fee to contribute to advertising and marketing.
4. As the number of participating Company locations increase and the amount of auto body collision & painting accepted estimates increase there may be substantial vendor opportunities (i.e., auto paint supply and material providers) for marketing, training and operational funding.)

As the program grows additional opportunities for revenue generation will also grow to include the formation of a buying unit that could negotiate national/regional pricing with paint, material, parts and equipment providers. Since most body shops are independently owned, becoming part of the Company's buying program could provide substantial saving they currently do not enjoy. At the same, the Company would earn revenues between the negotiated national/regional price and the price sold to the stores. Additional revenues opportunities could be developed through services provided that could include training, website participation (both internet and intranet), participation in 20/20 discussion groups, business analysis tools, etc.

Collection issues will be avoided by having the Company's stores collect the estimated amount and subtract the estimating fee and royalty and remit the balance to the body shop.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

What is claimed is:

1. A system as described herein.

2. A method as described herein.
